(19) United States
(12) Patent Application Publication
(10) Pub. No.: US 2009/0067026 A1
(43) Pub. Date: Mar. 12, 2009

(54) Low cost control system for solar concentrators

(76) Inventor: Lawrence Decker Winiarski, Corvallis, OR (US)

Correspondence Address: LAWRENCE WINIARSKI, 24395 STARR CREEK ROAD, CORVALLIS, OR, 97333, US

(21) Appl. No.: 11/974,298

(22) Filed: Oct. 12, 2007

Related U.S. Application Data
(60) Provisional application No. 60/851,802, filed on Oct. 12, 2006.

(51) Int. Cl. G02B 26/08

(52) U.S. Cl. 359/226.1

(57) ABSTRACT

a means of positioning a large number of mirrors accurately and inexpensively over a larger area by using floats and combined with mechanical linkages.

### CROSS-REFERENCE TO RELATED APPLICATIONS

This application claims the benefit of provisional patent application Ser. No. 60/851,802 filed Oct. 12, 2006 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention relates to control systems for solar concentrators.

2. Prior Art

After the invention of the steam engine, many people attempted to use the sun to produce heat to run a steam engine without fuel. This was accomplished in the 1800's but it proved difficult to compete economically with other forms of energy. The sunlight itself is free but the energy is diffuse. As an example: a square meter in the southwestern United States, gets about 2000 kilowatt-hours of solar energy annually. With a typical conversion efficiency of 15% this means each square meter can produce 300 kilowatt-hours of electricity. At current wholesale electrical rates of $0.05, this produces a meager $15 dollars of electricity annually per square meter. A photovoltaic panel would typically cost 30-40 times this amount per square meter or around $600-$800,

Since the energy conversion device is typically much more expensive than mirrors, it has proven to be more cost effective to concentrate the light from a larger area of mirrors onto a smaller energy conversion device. this has been done with both solar thermal, and photovoltaics, There are many different solar concentrator geometries, but all have still proven to be very expensive. Large moving structures have fewer moving parts, but larger construction costs as they must be strong and rigid enough to support their own weight and the effects of wind. Likewise small moving parts are cheaper to construct, but require more control systems to track the sun. These control systems have typically consisted of motors and complex transmissions are distributed throughout the array. If they are electronically controlled, then this further adds to the cost. Additionally these control systems need to be protected from the weather which further increases costs.

A method of using a float combined with a gear train and small valves for was proposed in U.S. Pat. No. 3,986,021 as a way of providing the necessary power to move a single reflector element very accurately by sensing solar radiation and operating valves to fill or empty a container, but all passive systems suffer with partial cloud cover and can end up “seeking”. Additionally, the actual power requirements required to move a panel are quite small, and valves are not substantially cheaper than motors, so this method never achieved widespread adoption

It is well known, by those skilled in the art, that it is possible to mechanically gang large numbers of mirrors with gears, rigid linkages or taut cables in such a way that given 2 axes of rotation, they track the sun and be focused on a small planar target, or with 1 axis of rotation they can be focused on a linear target. Some methods are described in U.S. Pat. No. 4,466,423, and U.S. Pat. No. 4,110,010 These methods reduces the number of motors and feedback sensors, but mechanical linkages suffer from bends, twist, sag, stretch, compression, expansion and contraction, and these factors tend to induce errors which become larger as the elements become further apart, these errors are difficult and expensive to compensate for which limits their use to relatively small distances and small forces and small temperature changes.

### OBJECTS AND ADVANTAGES

By using the natural leveling features of liquids, it is possible to very accurately connect and control many small panels over large areas using simple tubing, buckets and floats. Since these panels can be made relatively small, and individually calibrated, the overall concentration of the system can be very high even while using very crude methods. Also, again, because of the natural leveling properties of liquids, it is not necessary to have a feedback mechanism for each moving part, rather only 1 feedback method is necessary, and it is assured that all other moving parts will move in consort as though they were mechanically linked, but the problems of mechanical linkage such as stretching and sagging are eliminated as gravity naturally compensates for any differences in level.

Because this tracking mechanism can be made accurate and inexpensive, it facilitates further cost reductions because now, it is becomes cost effective to accurately control many small non-rigid reflectors over a larger area, rather than a smaller number of large rigid reflectors.

### SUMMARY OF THE INVENTION

The present invention is for controlling an array of solar reflectors onto a target. The reflectors are controlled through linkages connecting them to floats. The floats float in buckets or troughs which are further connected with tubes or canals such that the same level exists in a plurality of buckets. A pump or pumps is connected to the buckets, so that liquid may be exchanged with a separate holding tank or pond, which serves as a reservoir. By pumping liquid from the reservoir, to the connected buckets, it raises the plurality of floats which move in unison. which can then be mechanically linked to move the mirrors to a preferred direction. By pumping liquid out of the buckets into the reservoir, it lowers the plurality of floats, which cause the mirrors to move again in unison just as though they were connected through a mechanical means.

### BRIEF DESCRIPTION OF FIGURES

FIG. 1 shows a linear fresnel configuration in cross section.

FIG. 2 shows a linear fresnel configuration in a perspective view

FIG. 3 shows a linear fresnel configuration in an isometric view

FIG. 4 shows a parabolic trough configuration controlled by 3 floats

FIG. 5 shows a 2 dimensional mirror element controlled with 2 liquid levels, 1 for altitude control, and 1 for azimuth control

FIG. 6 shows an array of parabolic dishes kept in alignment with the sun using the linkage of FIG. 5

FIG. 7 shows a modification to the linkage in FIG. 5 which allows each reflector to direct it's energy toward a common target

### DETAILED DESCRIPTION

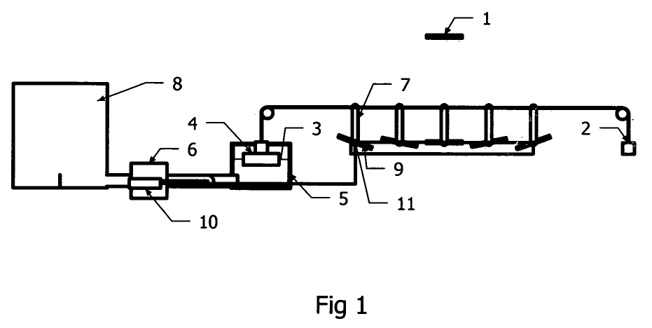

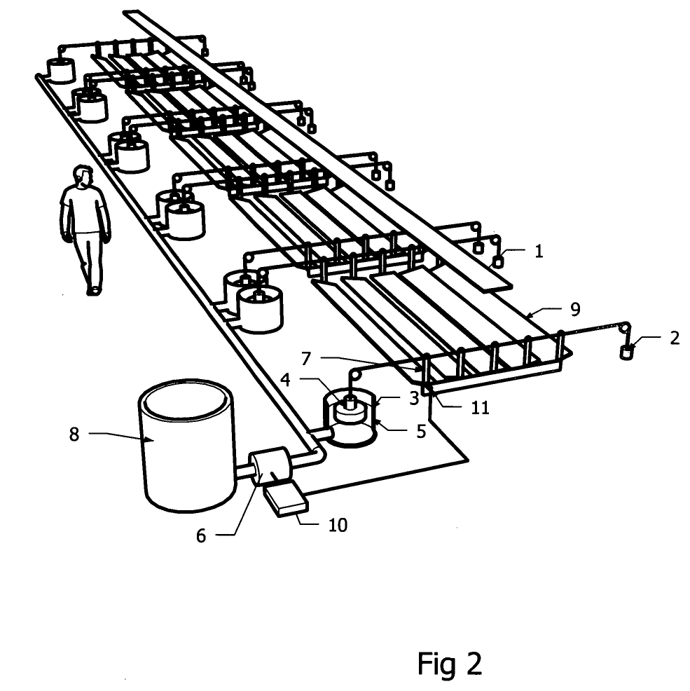

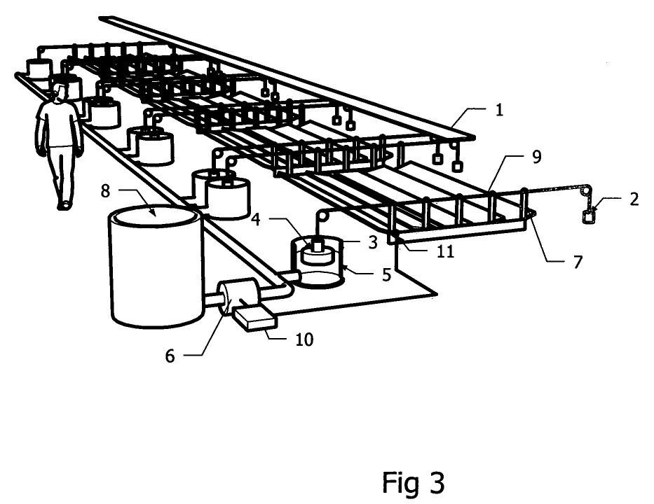

A preferred embodiment of the present invention is illustrated in FIG. 1, and FIG. 2 and FIG. 3. which illustrate the invention as applied to a linear fresnel geometry in the north-south geometry.

When the sun is directly overhead, the buckets 5 are ½ full and the arms 7a on the control linkage 7 are all pointing vertical. Each mirror 9 is adjusted with a relative angle from it's control arm 7a in such a way that the sunlight is focused on the target 1. This angle is now fixed and now the system is calibrated. Now the pump 6 can be controlled by a computer 10 which uses angle sensor 11 as a feedback device along with the time and geographic location in such a way that is known to those skilled in the art so that the liquid from the reservoir 8 moves into the array of buckets 5 in such a way as to keep the sunlight focused on the target as the sun moves across the sky.

It should be noted that if the buckets are on the east side of the mirrors, that they should fill as the day goes by, but if the buckets are on the west side, then they should empty as the day progress. In a system which has many buckets, it may prove advantageous to have both such systems, so that as the west set of buckets is emptying into the reservoir, the east set of buckets is filling from the reservoir. In this way a smaller reservoir can be used.

It should be noted that there could be many different means of moving the liquid from the reservoir, which could include multiple pumps or valves, or possibly by hand, and that the reservoir itself could be a river, or water supply, or rain bucket.

It should also be noted that the computer could be replaced with a mechanical timer or the system could be controlled manually. Any number of feedback systems could be possible such as pressure sensors, or angle measuring devices.

It should also be noted, that there are many different liquids possible that have useful properties such as inhibiting evaporation or inhibiting freezing.

It should also be noted that the buckets need no particular shape, and could be holes, troughs or canals.

An alternative embodiment would be the above system with the target aligned in the east-west geometry.

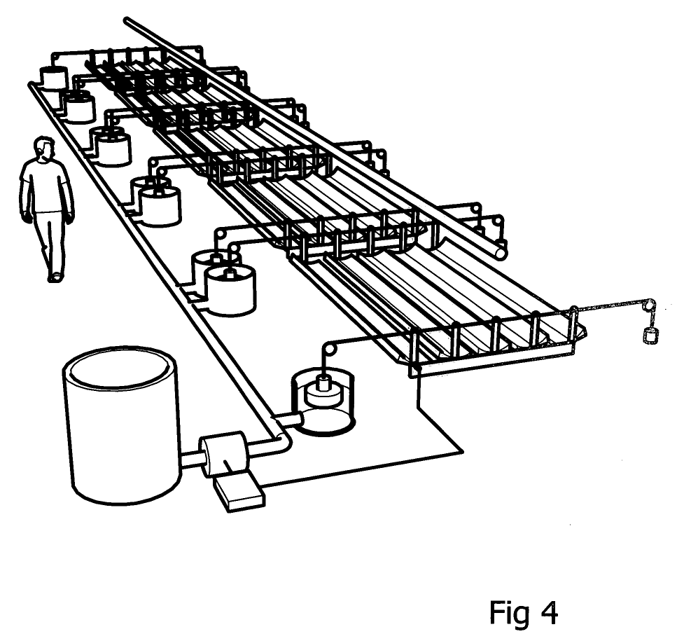

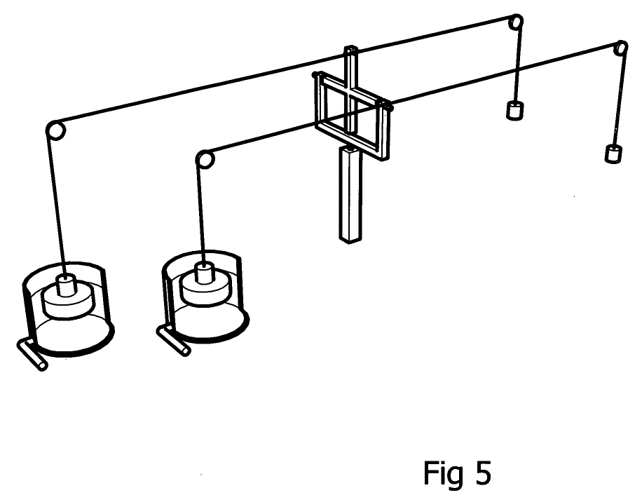

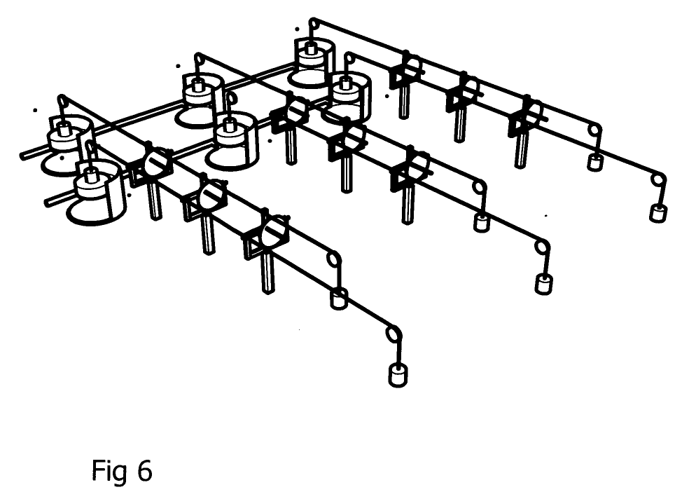

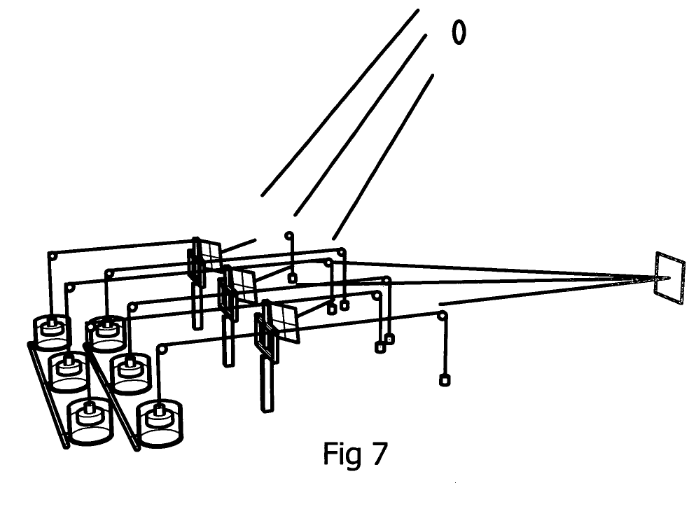

Other embodiments are possible such as a rotating parabolic troughs as shown in FIG. 4 It should also be apparent that this technique is not limited to the linear systems, but could be applied to 2 axis systems as shown in FIG. 5. The linkage in FIG. 5. could be also be used to keep an array of parabolic dishes in identical alignment as show in FIG. 6. Another example is shown in FIG. 7 which uses an angle bisecting linkage as a modification to the linkage shown in FIG. 5. which could be used to keep an array of reflectors pointed toward a common point.

From the description above, the advantages should become evident.
(a) A single pump can be used to control the angle of thousands of mirror systems very accurately and does not require an expensive feedback system as the level of the liquid will be the same everywhere due to gravity.
(b) linkages can be kept short.
(c) many mirrors can be connected to the same float, but can be mechanically linked so that they point in different ways or the same way.
(d) the system is very inexpensive.
(e) the system is simple and robust and needs little protection from the weather.
(f) the system is mechanical and troubleshooting can be done visually.

Accordingly, the reader will see that such a system provides a mechanical reference which is very accurate, and can be duplicated over large areas with little cost. this reference can then be used with a mechanical linkage to slave a mirror in a preferred direction such as would be well known to those skilled in the art.

Although the above description contains many specificities, these should not be construed as limiting the scope of the invention but as merely providing illustrations of some of the presently preferred embodiments of the invention. Thus the scope of the invention should be determined by the appended claims and their legal equivalents, rather than by the examples given.

What is claimed is:

1. A system for rotating a plurality of reflectors so that each reflector can rotate to a particular position in response to a given liquid level comprising:
a. a plurality of reflector elements mounted in such a way as said reflector element may rotate to all the preferred positions for said reflector element
b. a liquid level means
c. a float means which operates to move vertically as the level of liquid in the liquid level means changes
d. a plurality of linkage means which connect each reflector element to a float means and operate to rotate said reflector element to a preferred direction in response to a specific position of said float means
e. a method for changing the level of the liquid in the liquid level means

2. A system as in claim 1, where the reflectors are in a linear fresnel configuration.

3. A system as in claim 1, where the reflectors are in a linear fresnel configuration and a the method for changing the liquid level is one or more pumps, controlled by a computer with feedback provided by an angle sensor

4. A system as in claim 1, where the reflectors are in the parabolic trough configuration

5. A method for rotating a large number of reflectors as in claim 1, but each reflector can rotate in 2 axis and 2 liquid levels are used

6. A method for rotating a large number of reflectors as in claim 1, but each reflector is a parabolic dish and can rotate in 2 axis, and 2 liquid levels are used

7. A method for rotating a large number of reflectors as in claim 1, but each reflector can rotate in 2 axis, and 2 liquid levels are used, and a point focus geometry is used
